(19) United States
(12) Patent Application Publication
(10) Pub. No.: US 2003/0048228 A1
(43) Pub. Date: Mar. 13, 2003

(54) Antenna device using in a shielded environment

(76) Inventor: Ching Yee Chen, Tao Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/950,600

(22) Filed: Sep. 13, 2001

(51) Int. Cl. H01Q 1/32

(52) U.S. Cl. 343/713; 343/711

(57) ABSTRACT

An antenna device, especially, used in a shielded environment, is disclosed. The antenna device comprises an external receiving antenna installed at an outer side of a shielded environment for receiving signals from a satellite; an internal receiving antenna installed internal a shielded environment for receiving signals emitted from a satellite; a signal amplifying device electrically connected to the external receiving antenna and the internal receiving antenna; and a power supply device connected to the signal amplifying device for supplying power to the antenna device. Satellite signals are received by the external receiving antenna. Then the signals are amplified by the signal amplifying device, and then are emitted to ward a shielded environment by the internal receiving antenna. Thereby, the wireless device is usable in the shielded environment.

### FIELD OF THE INVENTION

The present invention relates to an antenna device, wherein satellite signals are received by the external receiving antenna, then the signals are amplified by a signal amplifying device, then are emitted toward a shielded environment by a internal receiving antenna, thereby, the wireless device is usable in the shielded environment.

### BACKGROUND OF THE INVENTION

Recently, with the advance in space and communication technologies, information is more and more important to most people. For example, wireless communication devices transmitting signals through satellites or Global Positioning System (GPS) used by individuals are more and more popular. In GPS system, the position of an object is calculated by the information from the satellites around Earth. Moreover, GPS may be used to program a traveling path. However, since satellite signals are easily shielded by objects, in a shielded environment, for example, interior of a building or an inner space of a vehicle, the device of GPS can not be used.

Therefore, there is an eager demand for a novel design for resolving the aforesaid problems.

### SUMMARY OF THE INVENTION

Accordingly, the primary object of the present invention is to provide an antenna device, wherein satellite signals are received by an external receiving antenna, then the signals are amplified by a signal amplifying device, then are emitted toward a shielded environment by an internal receiving antenna, thereby, the wireless device is usable in the shielded environment.

Another object of the present invention is to provide an antenna device, wherein a front-end amplifier is installed between the external receiving antenna and the signal dispatching circuit and is used for amplifying the receiving signals of the external receiving antenna.

Another object of the present invention is to provide an antenna device, wherein a signal dispatching circuit is used to dispatch received signals to circuits of different frequency band for further processing.

Another object of the present invention is to provide a antenna device, wherein the signal amplifying device includes filters of different frequency bands connected to the external receiving antenna for filtering noises in the received signals.

Another object of the present invention is to provide an antenna device, wherein the signal amplifying device includes a signal mixing circuit for mixing signal processed in different frequency band.

The other object of the present invention is to provide an antenna device, wherein the signal amplifying device includes a power supply device connected to an output end of the filter for amplifying signals with noise being filtered; then transferring the signal to a internal receiving antenna to emit toward a shielded environment.

To achieve aforesaid object, the present invention provides an antenna device, especially, used in a shielded environment, is disclosed. The antenna device comprises an external receiving antenna installed at an outer side of a shielded environment for receiving signals from a satellite; an internal receiving antenna installed internal a shielded environment for receiving signals emitted from a satellite; a signal amplifying device electrically connected to the external receiving antenna and the internal receiving antenna; and a power supply device connected to the signal amplifying device for supplying power to the antenna device. Satellite signals are received by the external receiving antenna. Then the signals are amplified by the signal amplifying device, and then are emitted to ward a shielded environment by the internal receiving antenna. Thereby, the wireless device is usable in the shielded environment.

The various objects and advantages of the present invention will be more readily understood from the following detailed description when read in conjunction with the appended drawing.

### BRIEF DESCRIPTION OF THE DRAWINGS

FIG. 1 is a circuit block diagram of a preferred embodiment of the present invention.

FIG. 2 is a schematic view showing an application of FIG. 1.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

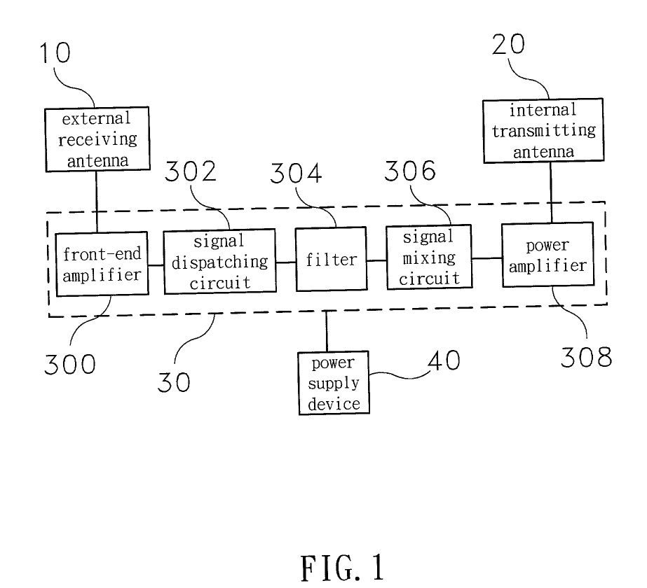

At first, referring to FIG. 1, a circuit block diagram of a preferred embodiment of the present invention is illustrated. As shown in the figure, the antenna device of the present invention includes an external receiving antenna 10, an internal transmitting antenna 20, a signal amplifying device 30, and a power supply device 40. The power supply device 40 is connected to the signal amplifying device 30 for supplying power to the whole device. The external receiving antenna 10 is installed at the outer side of a shielded environment for receiving information from a satellite. Then the received signal is amplified by the signal amplifying device 30 for improving the availability of the signal transmission. Finally, an internal transmitting antenna 20 in the shielded environment emits an amplified signal toward the interior of the shielded environment. Therefore, a wireless device can be used in the shielded environment.

In the present invention, the signal amplifying device 30 includes a signal dispatching circuit 302, a filter 304, a signal mixing circuit 306, and a power amplifier 308. The signal dispatching circuit 302 is electrically connected to an external receiving antenna 10 for classifying the received wide band satellite signal received by the external receiving antenna 10 according to the transmission band. Then, a filter 304 serves to filter the noise in each frequency band. The signal amplifying device 30 serves to mix the signals with noise being filtered to be as noiseless wide band signal. Finally, the power amplifier 308 serves to amplify the noiseless wide band signals. By the internal transmitting antenna 20, the signal is emitted toward the interior of the shielded environment. Therefore, the satellite wireless device is usable in the shielded environment to present a powerful function.

Moreover, in the signal amplifying device 30, a front-end amplifier 300 can be installed between an external receiving antenna 10 and a signal dispatching circuit 302 for amplifying the signal received by the external receiving antenna 10. Therefore, the faults in the signal dispatching circuit 302, filter 304, and signal mixing circuit 306 due to weak received signals is avoided and moreover, the reliability of signal transmission is increased.

Moreover, the antenna device of the present invention may be used in various conditions. If the power supply device 40 is a battery set, then the device may be a portable device. If the antenna is desired to be installed to a building, then the power supply device 40 can be connected to a power receptacle. Power can be supplied by a general used home power source. Besides, if an antenna is desired to the installed to a car or other vehicles. Then the power supply can be designed to include a cigar lighter receptacle for being installed to a cigar lighter receptacle of a car.

Moreover, the antenna of the present invention may be connected to a stereo of a vehicle (for example a car). Therefore, the antenna of the stereo is used as the external receiving antenna 10, while the power supply device 40 is connected to the power of the stereo.

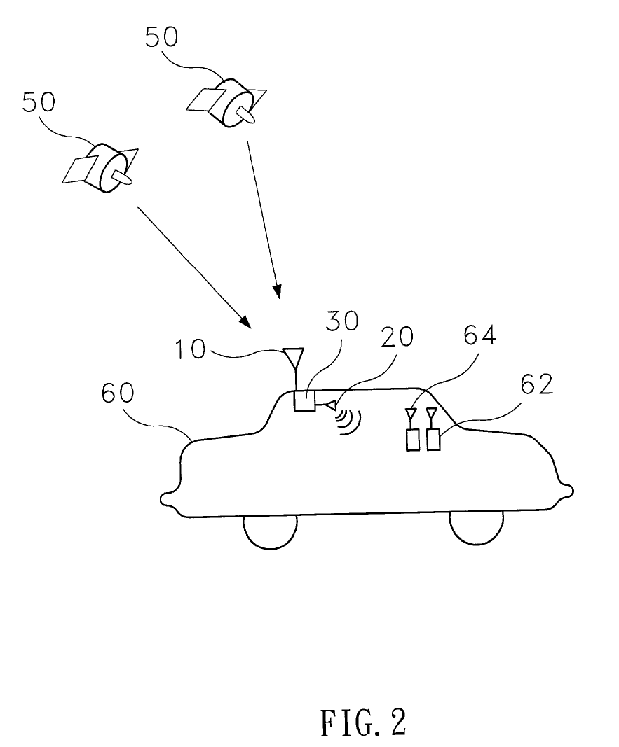

Referring to FIG. 2, a schematic view about the application of the embodiment of FIG. 1 is illustrated. As shown in the figure, when the antenna device of the present invention is installed to a car 60, the external receiving antenna 10 may be installed to be out of the car 60. The signal amplifying device 30 is installed at any position in the car 60 so that the internal transmitting antenna 20 emits signals toward the inner space. Therefore, the external receiving antenna 10 may be used to receive signals from the satellite 50. Then the signal is amplified by the signal amplifying device 30. Then, the processed signal is emitted toward the inner space of the shielded car by the internal transmitting antenna 20. The GPS 62 and satellite wireless device 64 can be used to receive a complete signal to be operated in normal.

In summary, the present invention relates to an antenna device, and particularly to an antenna device used in a shielded environment. An external receiving antenna is used to receive a satellite signal and a signal amplifying device is used to amplify signals. Then the internal receiving antenna emits signals toward a shielded environment. Therefore, a wireless device is usable in a shielded environment.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An antenna device used in a shielded environment comprising:
an external receiving antenna installed at an outer side of a shielded environment for receiving signals from a satellite;
an internal receiving antenna installed internal a shielded environment for receiving signals emitted from a satellite;
a signal amplifying device electrically connected to the external receiving antenna and the internal receiving antenna; and
a power supply device connected to the signal amplifying device for supplying power to the antenna device;
wherein satellite signals are received by the external receiving antenna, then the signals are amplified by the signal amplifying device, and then are emitted toward a shielded environment by the internal receiving antenna, thereby, the wireless device being usable in the shielded environment.

2. The antenna device as claimed in claim 1, wherein the signal amplifying device comprising:
a filter connected to the external receiving antenna for filtering noises in the received signals; and
a power supply device connected to an output end of the filter for amplifying signals with noise being filtered; then transferring the signal to the internal receiving antenna to be emitted toward the shielded environment.

3. The antenna device as claimed in claim 2, wherein a signal dispatching circuit is installed between the external receiving antenna and the filter for dispatching the received signals in response to the frequency band; a signal mixing circuit is connected between the filter and the power amplifier for mixing signals with noise being filtered and then transferring the signal to a power amplifier for amplifying signals.

4. The antenna device as claimed in claim 2, wherein a front-end amplifier is installed between the external receiving antenna and the signal dispatching circuit.

5. The antenna device as claimed in claim 3, wherein the power supply device is a battery set.

6. The antenna device as claimed in claim 3, wherein the power supply device includes a cigar lighter receptacle.

7. The antenna device as claimed in claim 3, wherein the power supply device is connected to a power receptacle.

8. The antenna device as claimed in claim 3, wherein the internal receiving antenna is an antenna of a car.

9. The antenna device as claimed in claim 3, wherein the power supply device is connected to a power source of a car stereo.
10 external receiving antenna
20 internal transmitting antenna
300 front-end amplifier
30 signal amplifying device
302 signal dispatching circuit
304 filter
306 signal mixing circuit
308 power amplifier
40 power supply device
